(19) United States
(12) Patent Application Publication
(10) Pub. No.: US 2022/0240022 A1
(43) Pub. Date: Jul. 28, 2022

(54) AUDIO REPRODUCING APPARATUS AND AUDIO DEVICE

(71) Applicant: SONY GROUP CORPORATION, TOKYO (JP)

(72) Inventors: TOSHIYUKI NAKAGAWA, TOKYO (JP); YOSHIO OHASHI, TOKYO (JP); JUNKO KATSURAKU, TOKYO (JP); ASAMI YAMAGISHI, TOKYO (JP)

(21) Appl. No.: 17/596,269

(22) PCT Filed: Jun. 16, 2020
(86) PCT No.: PCT/JP2020/023598

§ 371 Date: Dec. 7, 2021

(30) Foreign Application Priority Data
Jun. 17, 2019 (JP) 2019-111819

(51) Int. Cl. H04R 17/00; H04R 7/10; H04R 1/02

(52) U.S. Cl. CPC H04R 17/00; H04R 1/025; H04R 7/10

(57) ABSTRACT

An audio reproducing apparatus that includes an audio device including a thin film material including a first electrode layer, a second electrode layer, and a capacitive layer sandwiched between the first electrode layer and the second electrode layer, the audio device having a three-dimensional shape formed by providing the thin film material with a plurality of fold parts.

### TECHNICAL FIELD

The present disclosure relates to an audio reproducing apparatus and an audio device.

### BACKGROUND ART

As an audio device, devices are known in which a piezoelectric material is used. Patent Documents 1 and 2 disclose such an audio device in which a piezoelectric material is used.

### CITATION LIST

### Patent Document

Patent Document 1: Japanese Patent Application Laid-Open No. 59-158199
Patent Document 2: Japanese Patent Application Laid-Open No. 2011-97181

### SUMMARY OF THE INVENTION

### Problems to be Solved by the Invention

In such a field, it is desired to form a shape according to various applications and the like.

### Solutions to Problems

The present disclosure provides, for example,

an audio reproducing apparatus including

an audio device including a thin film material including a first electrode layer, a second electrode layer, and a capacitive layer sandwiched between the first electrode layer and the second electrode layer, the audio device having a three-dimensional shape formed by providing the thin film material with a plurality of fold parts.

Provided is an audio device including

a thin film material including a first electrode layer, a second electrode layer, and a capacitive layer sandwiched between the first electrode layer and the second electrode layer, the audio device having a three-dimensional shape formed by providing the thin film material with a plurality of fold parts.

### BRIEF DESCRIPTION OF DRAWINGS

FIG. 1 is a diagram to explain a principle of a piezoelectric element.

FIG. 2 illustrates a configuration of an audio device.

FIG. 3 is a diagram illustrating a configuration of an audio reproducing apparatus.

FIG. 4 is a diagram illustrating a configuration of an audio reproducing apparatus.

FIG. 5 is a diagram illustrating a configuration of an audio reproducing apparatus.

FIG. 6 is a flowchart illustrating a manufacturing process of an audio device.

FIG. 7 is a block diagram illustrating a control configuration of an audio reproducing apparatus.

FIGS. 8(A) and 8(B) are diagrams illustrating a configuration of an audio reproducing apparatus.

FIG. 9 is a diagram illustrating a configuration of an audio reproducing apparatus.

FIG. 10 is a diagram illustrating a configuration of an audio reproducing apparatus.

FIG. 11 illustrates a configuration of an audio device.

FIG. 12 is a diagram illustrating a configuration of an audio reproducing apparatus.

FIG. 13 is a diagram illustrating a configuration of an audio reproducing apparatus.

FIG. 14 is a diagram illustrating a configuration of an audio reproducing apparatus.

FIG. 15 is a diagram illustrating a configuration of an audio reproducing apparatus.

FIG. 16 is a diagram illustrating a configuration of an audio reproducing apparatus.

FIGS. 17(A) and 17(B) are diagrams illustrating a configuration of an audio device.

FIGS. 18(A) and 18(B) are diagrams illustrating a configuration of an audio device.

FIGS. 19(A) and 19(B) are diagrams explaining bending of a piezoelectric sheet.

FIGS. 20(A) and 20(B) are diagrams explaining bending of a piezoelectric sheet.

FIG. 21 is a diagram illustrating a configuration of an audio device.

FIGS. 22(A) to 22(D) are diagrams illustrating a configuration of an audio device.

FIG. 23 is a diagram illustrating a configuration of an audio reproducing apparatus.

FIG. 24 is a developed view of the audio device in FIG. 23.

FIG. 25 is a diagram illustrating a configuration of the audio device in FIG. 23.

FIG. 26 is a diagram to explain a configuration of an audio reproducing apparatus.

FIG. 27 is a diagram to explain a configuration of an audio reproducing apparatus.

FIG. 28 is a diagram to explain a configuration of an audio reproducing apparatus.

FIG. 29 is a diagram to explain a configuration of an audio reproducing apparatus.

FIG. 30 is a diagram to explain a configuration of an audio reproducing apparatus.

FIG. 31 is a diagram illustrating a configuration of an audio reproducing apparatus.

FIG. 32 is a developed view of the audio device in FIG. 31.

FIG. 33 is a diagram illustrating a configuration of an audio reproducing apparatus.

FIG. 34 is a diagram illustrating an operation part of an audio reproducing apparatus.

FIG. 35 is a diagram explaining an operation of an opening/closing part.

FIG. 36 is a diagram illustrating a configuration of an audio reproducing apparatus.

FIG. 37 is a developed view of the audio device in FIG. 36.

### MODE FOR CARRYING OUT THE INVENTION

Hereinafter, embodiments and the like of the present disclosure will be described with reference to the drawings. Note that the description will be given in the following order.

<1. Description of Principle of Piezoelectric Element>

<2. First Embodiment>

<3. Second Embodiment>

<4. Third Embodiment>

<5. Modified Examples>

<6. Fourth Embodiment>

<7. Fifth Embodiment>

<8. Sixth Embodiment>

<9. Seventh Embodiment>

The embodiments and the like described below are preferred specific examples of the present disclosure, and contents of the present disclosure are not limited to these embodiments.

### 1. Description of Principle of Piezoelectric Element

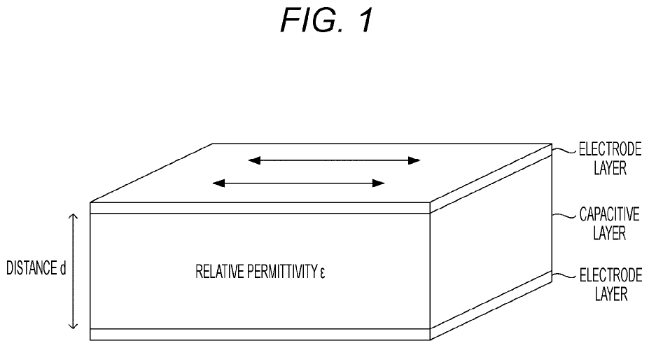

FIG. 1 is a diagram to explain a principle of a piezoelectric element. The piezoelectric element has a structure in which a capacitive layer is sandwiched between two electrode layers, and when a voltage is applied between the electrode layers, displacement occurs in the direction of arrows illustrated in FIG. 1. The audio reproducing apparatus of the present embodiment functions as a so-called speaker by converting the displacement amount of the piezoelectric element into vibration of air.

The piezoelectric element has a capacitance C having a relation of

C=εS/d

in which ε represents the relative permittivity of the dielectric included in the capacitive layer, d represents the distance between the electrodes, and S represents the area of the electrodes.

In addition, the capacitance C of the piezoelectric element is in inverse relation to the magnitude of the impedance Z, so that the impedance Z decreases as the capacitance C increases. Therefore, increase in the capacitance C indicates improvement in the sensitivity to voltage, that is, the larger the capacitance C is, the more easily the audio reproducing apparatus can obtain a large sound pressure.

Furthermore, the piezoelectric element can store a charge Q obtained as a product of the voltage V applied to the piezoelectric element and the capacitance C, that is, a charge Q having a relation of

Q=CV. Therefore, in order to store a certain amount of charge Q, if the capacitance is increased, a reduced voltage V is required, and the voltage V to obtain the required sound pressure can be small.

Here, regarding the vibration in the length direction, the displacement amount ΔL generated when the voltage V is applied between the electrode layers is given as follows in a case where d represents the distance between the electrode layers.

ΔL=a*V*L/d

Here, a represents a piezoelectric strain constant, that is, a strain generated when a unit electric field is applied in a state that no stress is applied. Therefore, it can be seen that in order to obtain a larger displacement amount ΔL, the distance between the electrode layers, d, is to be small, that is, a thin film is to be formed.

In the audio reproducing apparatus of the present embodiment, an audio device is used that is formed using a thin film-shaped piezoelectric element (thin film material). This audio device has a sheet shape having plasticity, and expands and contracts in the plane direction of the sheet as illustrated in FIG. 1 when a voltage is applied. The expansion and the contraction are converted into vibration of air, and thus can be used in the audio reproducing apparatus.

### 2. First Embodiment

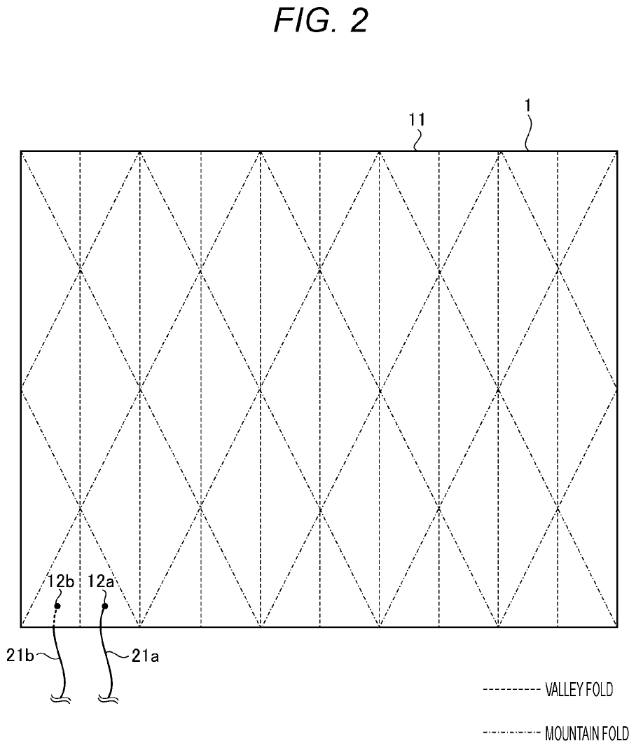

FIG. 2 is a diagram illustrating a configuration of an audio device 1 to be used in an audio reproducing apparatus 4, and is a developed view of the audio device 1 including a piezoelectric sheet 11 (thin film material) to be bent. The piezoelectric sheet 11 of the present embodiment includes two electrode layers and a capacitive layer sandwiched between the electrode layers as explained with reference to FIG. 1. The piezoelectric sheet 11 has a thickness of, for example, 30 μm to 100 μm, and the piezoelectric sheet 11 having a thickness of 30 μm to 60 μm is preferably used. Note that in the present embodiment, a reinforcing part configured to reinforce the piezoelectric sheet 11 is bonded to the entire region of the back surface of the piezoelectric sheet 11. In the reinforcing part, a nonwoven fabric or the like can be used. Note that the material of the reinforcing part is not necessarily to be a nonconductive material such as a nonwoven fabric, and is only to have a strength required for a desired audio reproducing apparatus. For example, a plurality of piezoelectric sheets bonded to each other is sufficient.

Furthermore, in the embodiment, a nonconductive protective layer including polyethylene terephthalate (PET) or the like is provided on the surface layer side of each of the two electrode layers. Therefore, when a signal line is connected to the electrode layer, the protective layer at the connection point is to be removed to expose the electrode layer. Note that although the piezoelectric sheet 11 is used in the present embodiment, various materials other than the piezoelectric sheet 11, such as an electrostatic sheet, can be used as long as the materials are a thin film material having a capacitive characteristic.

As illustrated in the developed view of FIG. 2, the piezoelectric sheet 11 is provided with valley fold parts indicated by a broken line and mountain fold parts indicated by a one-dot chain line as bend parts. In the present embodiment, there are points at which the mountain fold parts and the valley fold parts intersect respectively, and when the piezoelectric sheet 11 is bent at the bend parts, vertexes in the three-dimensional shape are formed at the points. In the present embodiment, a plurality of valley fold parts arranged to be parallel to each other and a plurality of mountain fold parts arranged to be parallel to each other but not parallel to the valley fold parts are formed. At this time, the valley fold parts and the mountain fold parts are arranged so that one valley fold part and two mountain fold parts intersect. Here, the surfaces in the piezoelectric sheet bent at the bend parts are not bonded to each other and have a degree of freedom.

Furthermore, as can be seen from the developed view of FIG. 2, the regions (section regions) sectioned off with the mountain fold parts and the valley fold parts have two different areas. Varying the areas of the section regions in this manner leads to varying the frequency regions obtained by vibration of the section regions, and allows, for example, the audio device 1 to attain a uniform frequency characteristic or a frequency characteristic of having a wide frequency region.

The piezoelectric sheet 11 includes two electrode layers and a capacitive layer sandwiched between the electrode layers as explained with reference to FIG. 1. In addition, in the present embodiment, a nonconductive protective layer including PET or the like is provided on the surface of each electrode layer. The two electrode layers in the audio device 1 are each provided with electrode parts 12a and 12b to which signal lines 21a and 21b are to be connected, respectively. The electrode parts 12a and 12b can be provided by removing the protective layer provided on the surface of each electrode layer. Note that as the piezoelectric sheet 11, a piezoelectric sheet having no protective layer can be used. In this case, the electrode layers are exposed. Therefore, for the electrode parts 12a and 12b, appropriate points can be used on the front and the back of the piezoelectric sheet 11.

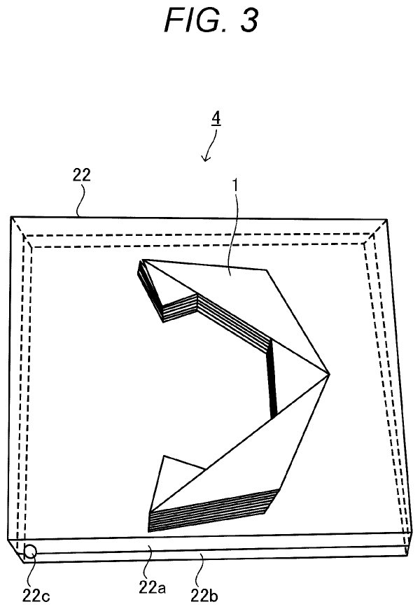

FIGS. 3 to 5 are diagrams illustrating a configuration of the audio reproducing apparatus 4. The audio device 1 bent in accordance with the developed view explained with reference to FIG. 2 is housed in a fixing part 22 and used in the audio reproducing apparatus 4. In the fixing part 22, a first base part 22a and a second base part 22b can be opened via a hinge part 22c like, for example, a compact disc case. The ends of the bent audio device 1 are fixed to the first base part 22a and the second base part 22b, respectively.

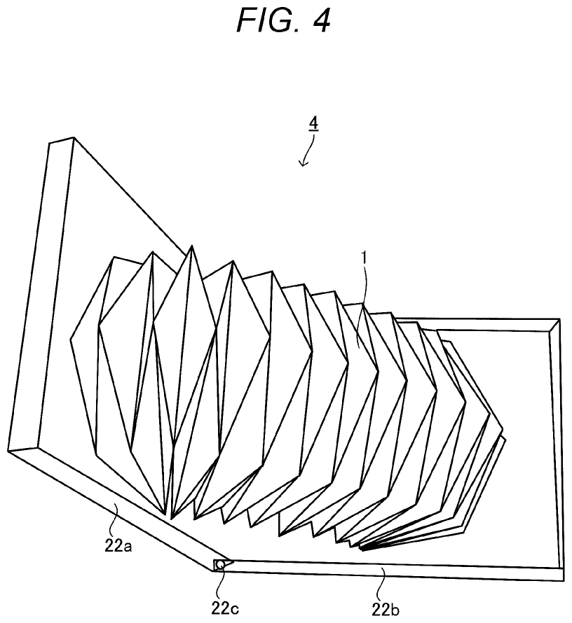

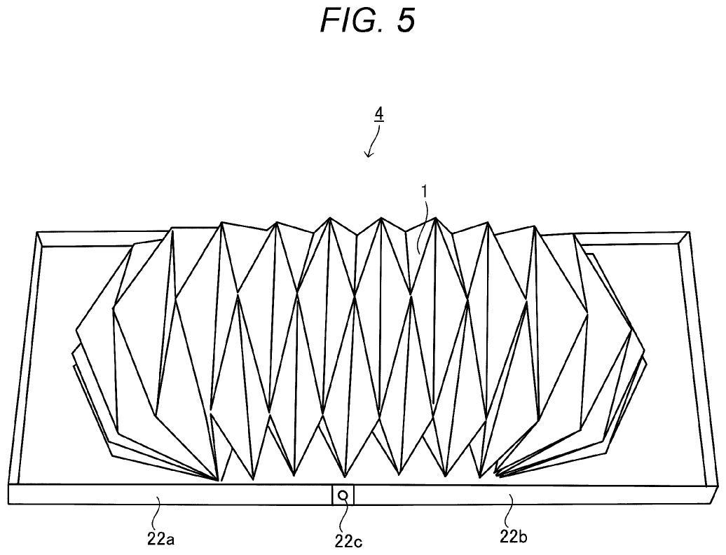

FIG. 3 illustrates a state in which the fixing part 22 is closed, and when the fixing part 22 is opened, the audio device 1 is expanded as in FIGS. 4 and 5 to form a three-dimensional shape. Note that FIGS. 3 to 5 omit the signal lines 21a and 21b connected to the audio device 1. As described above, by using the audio device 1 capable of expanding and contracting, the audio reproducing apparatus 4 of the present embodiment can have a compact folded shape as in FIG. 3 when not in use. When in use, the audio reproducing apparatus 4 can be in a state in which the audio device 1 is expanded as in FIGS. 4 and 5 to form a three-dimensional shape. Furthermore, varying the opening angle of the hinge part 22c leads to varying the degree of expansion of the audio device 1, and allows, for example, adjustment of the directivity or the frequency characteristic of the audio reproducing apparatus 4.

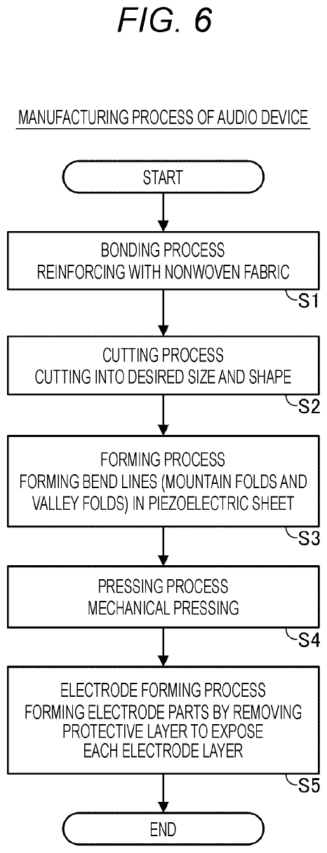

FIG. 6 is a flowchart illustrating a manufacturing process of the audio device 1. In the manufacturing process of the audio device 1, first, a bonding process (S1) is executed in which a reinforcing part such as a nonwoven fabric is bonded to the piezoelectric sheet 11 to be a material. The reinforcing part used in the bonding process functions so that the piezoelectric sheet 11 easily holds a three-dimensional shape. In the present embodiment, the reinforcing part is bonded to the entire region of the back surface of the piezoelectric sheet 11, but various forms can be employed such as a form in which the reinforcing part is partially provided or is divided and provided on the back surface of the piezoelectric sheet 11.

Next, a cutting process (S2) is executed in which the piezoelectric sheet 11 to which the reinforcing part is bonded is cut into a desired size and shape. Thereafter, as explained with reference to the developed view of FIG. 2, a forming process (S3) is executed in which the piezoelectric sheet 11 is bent at the mountain fold parts and the valley fold parts, and a pressing process (S4) is executed in which the piezoelectric sheet 11 bent in the forming process is mechanically pressed to make the mountain fold parts and the valley fold parts reliable. Note that in a case where the reinforcing part is bonded to the piezoelectric sheet 11 as in the present embodiment, the piezoelectric sheet 11 and the reinforcing part are to be bent together. Thereafter, the protective layer provided on the surface is removed to expose each electrode layer, and two electrode parts 12a and 12b are formed on the front and the back of the piezoelectric sheet 11.

In the audio device 1 formed with such a process, the ends are fixed to the first base part 22a and the second base part 22b of the fixing part 22, respectively, and the signal lines 21a and 21b are connected to the electrode parts 12a and 12b, respectively. Thus, the audio reproducing apparatus 4 illustrated in FIGS. 3 to 5 is formed.

In the present embodiment, the audio device 1 obtained by bending the piezoelectric sheet 11 is used to form a three-dimensional shape, and even if the volume is small, the piezoelectric sheet 11 can have a large area. Furthermore, many mountain fold parts and valley fold parts are provided, and as a result, it is possible to efficiently convert expansion and contraction in the direction parallel to the surface of the piezoelectric sheet 11 into aerial vibration. Therefore, it is possible to improve the sound pressure of the audio device 1. Furthermore, as explained with reference to FIGS. 3 to 5, the audio device 1 can be folded to form a compact shape when not in use, resulting in easy handling. Furthermore, as in FIGS. 4 and 5, the degree of expanding the audio device 1 can also be appropriately changed, and can be appropriately adjusted according to a use situation or a desired acoustic characteristic.

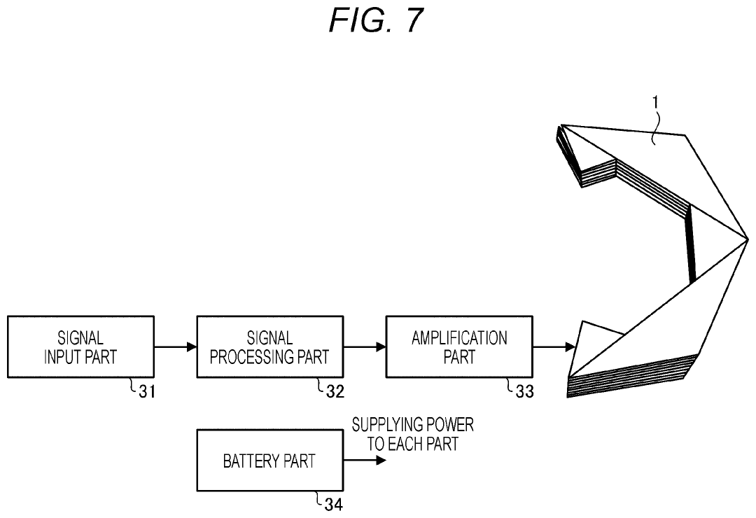

FIG. 7 is a diagram illustrating a control configuration of the audio reproducing apparatus 4. The control configuration of the audio reproducing apparatus 4 includes a signal input part 31, a signal processing part 32, an amplification part 33, and a battery 34. In the audio reproducing apparatus 4 illustrated in FIGS. 3 to 5, at least one of the signal input part 31, the signal processing part 32, the amplification part 33, or the battery 34 may be accommodated in the space in the fixing part 22. At this time, in the audio reproducing apparatus 4, it is preferable that the fixing part 22 can be closed as illustrated in FIG. 3 even at the time of accommodation. In the case of the audio device 1 as illustrated in FIGS. 3 to 5, a space is generated around the audio device 1 in a state of being folded as in FIG. 3, and thus, the space easily accommodates the control configuration such as the signal input part 31, the signal processing part 32, the amplification part 33, or the battery 34. In particular, in a case where the control configuration is positioned in the back side of the audio device 1 when the audio reproducing apparatus 4 is opened as in FIGS. 4 and 5, the control configuration is not recognized visually from the outside, and the audio reproducing apparatus 4 can be downsized.

The signal input part 31 may be a general audio signal connection such as a minijack or a pin jack, or at the signal input part 31, necessary equipment such as an antenna may be added and a wireless audio input may be performed using an audio profile function included in a short-range wireless communication standard for digital devices, such as Bluetooth (registered trademark).

The signal processing part 32 processes an acoustic signal input from the signal input part 32 to make the acoustic characteristic suitable. In addition, protection such as ultra-high frequency cut-off may also be performed if necessary. The amplification part 33 includes an amplifier having a necessary number of channels, and drives the audio device 1 with an amplified acoustic signal. The battery part 34 supplies power to each of the signal input part 31, the signal processing part 32, the amplification part 33, and the like.

### 3. Second Embodiment

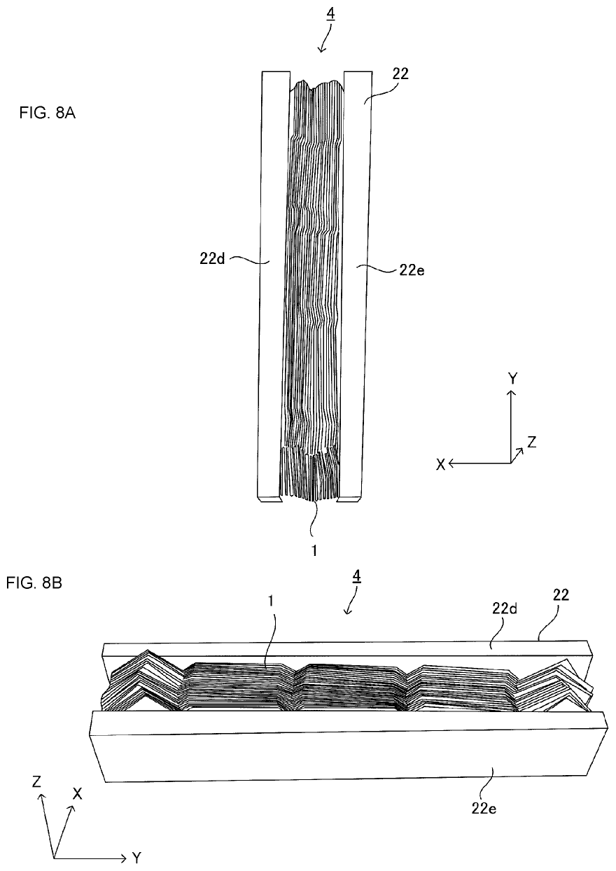

FIGS. 8 to 11 are diagrams to explain an audio reproducing apparatus 4 according to a second embodiment. As illustrated in the perspective views of FIGS. 8(A) and 8(B), the audio reproducing apparatus 4 of the present embodiment has a form in which a left fixing part 22d and a right fixing part 22e as a fixing part 22 are fixed to both ends of an audio device 1 that is folded. Note that in the left fixing part 22d and the right fixing part 22e, various materials can be used whose shape is less likely to change, and examples of such materials include wood and plastic. Note that FIGS. 8 to 10 illustrate a coordinate system indicated by XYZ axes so that the three-dimensional shape of the audio reproducing apparatus 4 can be easily understood.

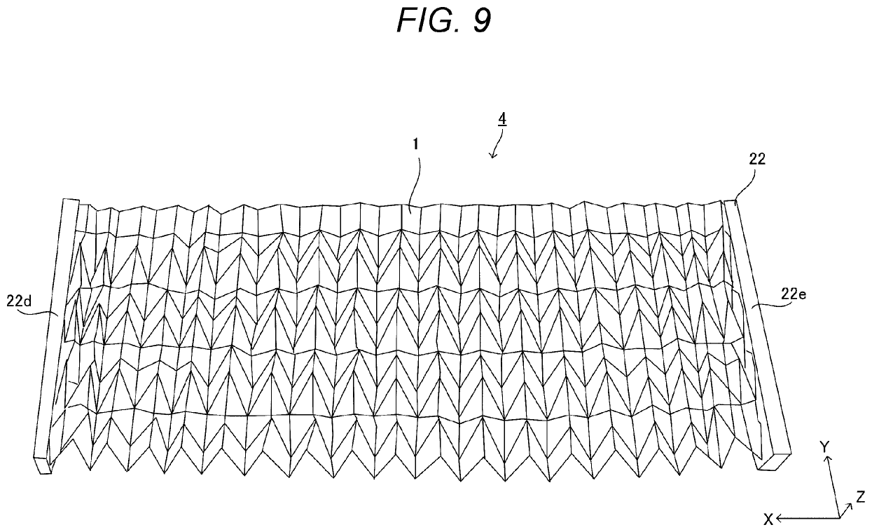

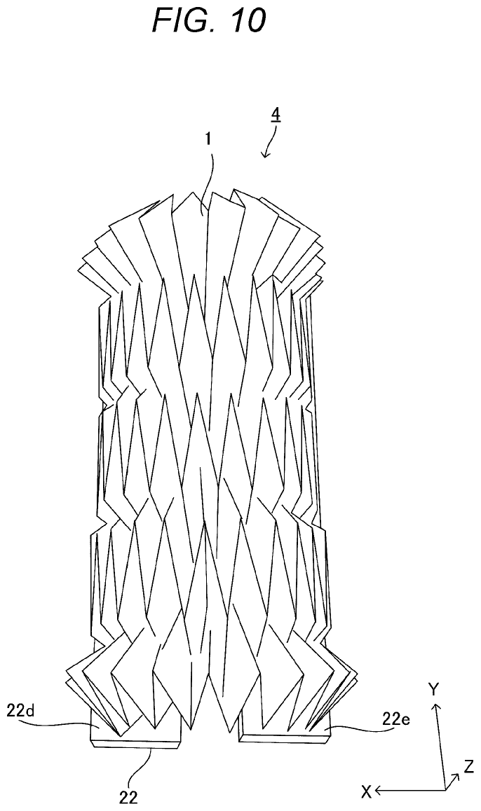

FIG. 8 illustrates the audio device 1 in a state of being folded, and the audio device 1 can change from this state to a state of being expanded as in FIG. 9 (state in which a three-dimensional shape is formed) by moving the left fixing part 22d and the right fixing part 22e away from each other in the X-axis direction. Furthermore, the audio device 1 can be expanded not only in a form expanded as in FIG. 9 but also in a cylindrical shape as in FIG. 10. In the case of FIG. 10, the audio device 1 expanded in a cylindrical shape may be wound around a cylindrical object. As described above, in the audio reproducing apparatus 4 of the present embodiment, the left fixing part 22d and the right fixing part 22e can move independently, and therefore the audio device 1 can be expanded in a free form in FIG. 9 or 10 or in another free form. Then, when not in use, the audio reproducing apparatus 4 is formed into a compact shape in a state of being folded as illustrated in FIGS. 8(A) and 8(B), and when in use, the audio device 1 is expanded in a free form as illustrated in FIGS. 9 and 10, and sound reproduction can be performed. Note that an appropriate auxiliary tool may be used to maintain the state illustrated in FIGS. 9 and 10.

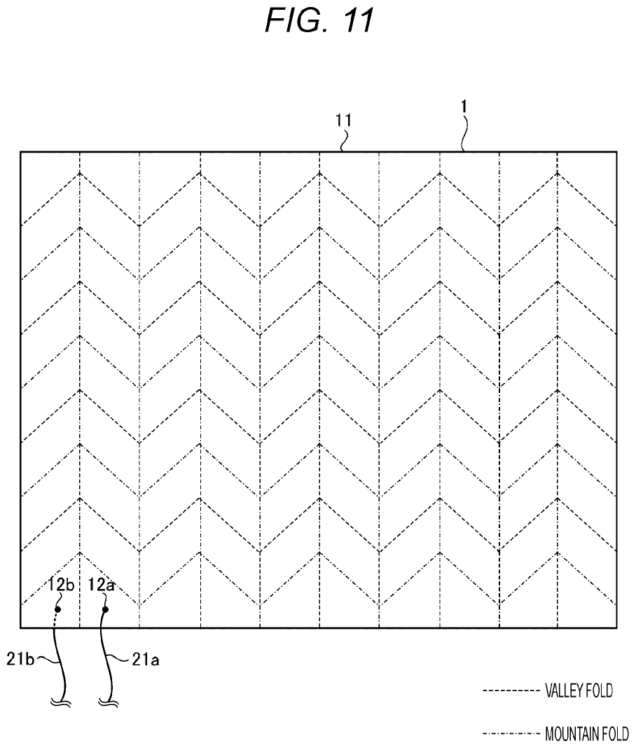

FIG. 11 is a diagram illustrating a configuration of the audio device 1 used in the second embodiment, and is a diagram showing a developed view of the audio device 1. Fold parts formed in a piezoelectric sheet 11 include a plurality of valley fold parts that has a zigzag shape extending in the left-right direction in FIG. 11 and is arranged to be parallel to each other, and include a plurality of mountain fold parts that is parallel to the valley fold parts and arranged alternately with the valley fold parts. In addition, the fold parts include connecting parts that are arranged to connect the vertexes of the mountain fold parts with the adjacent vertexes of the valley fold parts. The fold at one connecting part is different from the fold at the adjacent connecting parts. At the connecting part, the bent form (valley fold or mountain fold) is different from the forms at the adjacent connecting parts in the vertical direction and the lateral direction.

Also in the present embodiment, the regions (section regions) sectioned off with the mountain fold parts and the valley fold parts have two different areas. Specifically, the regions include the trapezoid section regions formed on both the upper and the lower ends of the audio device 1 and the parallelogram section regions formed in the middle of the audio device 1. Varying the areas of the section regions in this manner leads to varying the frequency regions obtained by vibration of the section regions, and allows, for example, the audio device 1 to attain a uniform frequency characteristic or a frequency characteristic of having a wide frequency region.

Furthermore, the audio device 1 is provided with electrode parts 12a and 12b to which signal lines 21a and 21b are to be connected, respectively. Furthermore, a reinforcing part including a nonwoven fabric is bonded to the entire back surface of the piezoelectric sheet 11 so that a three-dimensional shape is easily formed and held.

According to the present embodiment, it is possible to perform audio reproduction in which desired sound pressure and sound quality are secured while downsizing to an extremely small shape is achieved at the time of non-use, and at the time of use, an arbitrary shape is formed such as a form obtained by extending the extremely small shape.

### 4. Third Embodiment

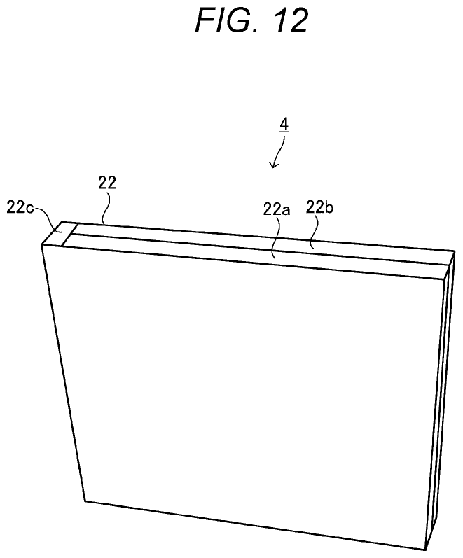

FIGS. 12 to 16 are diagrams to explain an audio reproducing apparatus 4 according to a third embodiment. In the second embodiment, the bent form of the piezoelectric sheet 11 is particularly different from that in the first embodiment.

FIGS. 12 to 16 are diagrams illustrating a configuration of the audio reproducing apparatus 4. An audio device 1 bent in accordance with the developed view explained with reference to FIG. 2 is housed in a fixing part 22 and used in the audio reproducing apparatus 4. In the fixing part 22, a first base part 22a and a second base part 22b can be opened via a hinge part 22c like, for example, a compact disc case. The ends of the bent audio device 1 are fixed to the first base part 22a and the second base part 22b, respectively. Note that in the fixing part 22 in FIG. 12, a non-transparent material is used, and therefore the accommodated audio device 1 is invisible from the outside.

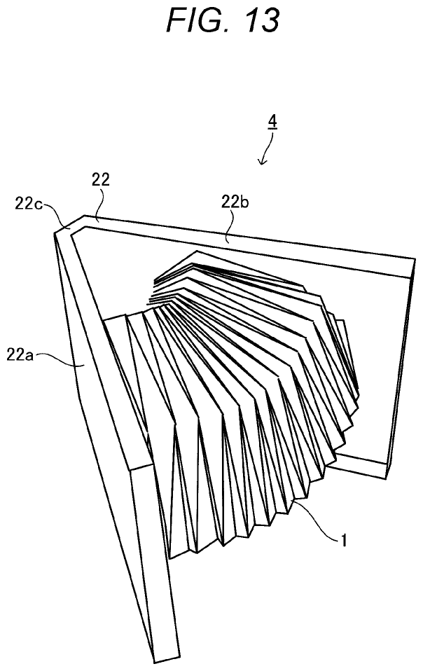

FIG. 12 illustrates a state in which the fixing part 22 is closed, and when the fixing part 22 is opened, the audio device 1 is expanded as in FIGS. 13 to 15 to form a three-dimensional shape. Note that FIGS. 12 to 16 omit the signal lines 21a and 21b connected to the audio device 1. As described above, by using the audio device 1 capable of expanding and contracting, the audio reproducing apparatus 4 of the present embodiment can have a compact folded shape as in FIG. 12 when not in use. When in use, the audio reproducing apparatus 4 can be in a state in which the audio device 1 is expanded as in FIGS. 13 to 15 to form a three-dimensional shape. Furthermore, varying the opening angle of the hinge part 22c leads to varying the degree of expansion of the audio device 1, and allows, for example, adjustment of the directivity or the frequency characteristic of the audio reproducing apparatus 4.

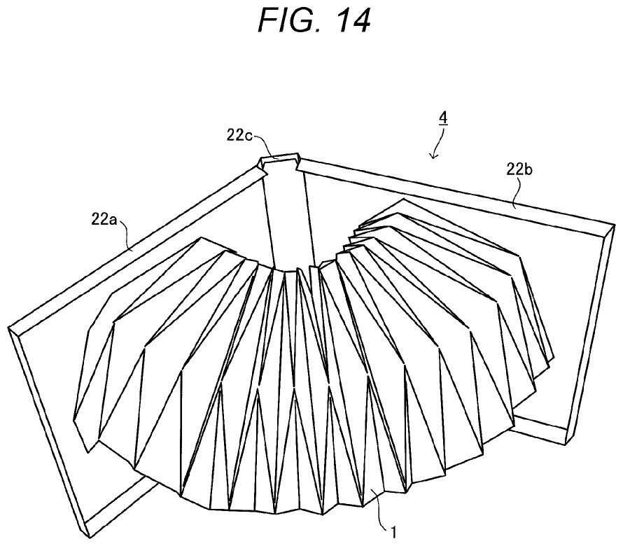

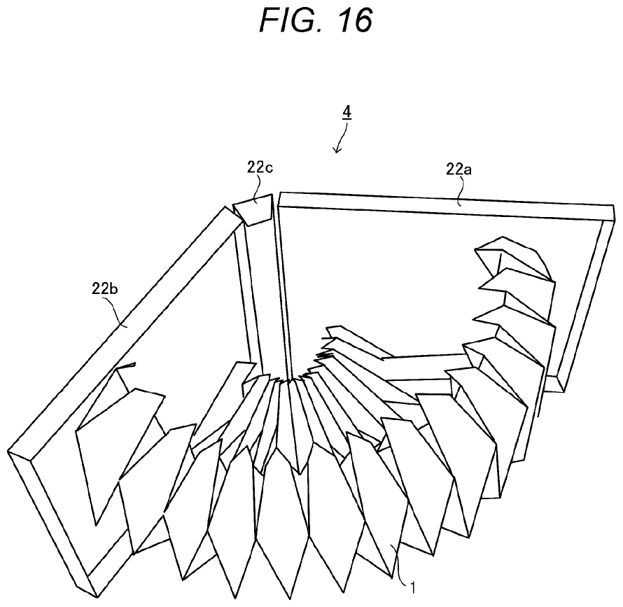

FIG. 16 is a perspective view of the state of FIG. 14 as viewed from below. The audio device 1 of the present embodiment has an asymmetric shape in the upper and lower direction. Therefore, as illustrated in FIG. 16, a space is formed that is open toward the lower side of the audio device 1. As described above, the audio device 1 used in the audio reproducing apparatus 4 of the present embodiment can employ an appropriate shape. Furthermore, in the present embodiment, by forming an open space in a part of the shape formed by the audio device 1, the back pressure of the audio device 1 is released to the outside, and an appropriate acoustic frequency characteristic can be formed. In addition, acoustic directivity can be imparted by folding into a shape in which the inside is exposed in the bent state.

According to an embodiment of the present disclosure, a three-dimensional shape can be formed in an audio device or an audio reproducing apparatus in which a thin film material having a capacitive characteristic is used.

### 4. Modified Examples

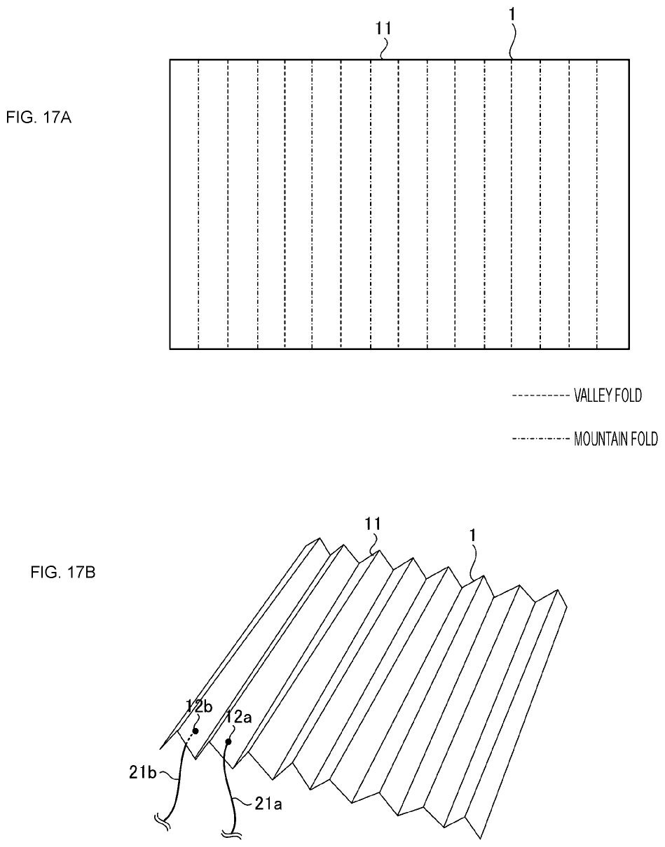

Next, various modified examples of the audio device 1 used in the audio reproducing apparatus 4 of the present embodiment will be described. FIG. 17 is a diagram illustrating a configuration of the audio device 1. FIG. 17(A) is a developed view of the audio device 1, and FIG. 17(B) is a perspective view of the audio device 1 provided with fold parts to be formed into a three-dimensional shape.

The audio device 1 illustrated in FIG. 17 is formed in a state in which mountain fold parts and valley fold parts are alternately arranged in rows. The audio device 1 is bent at the fold parts to form the three-dimensional shape illustrated in FIG. 17(B). The audio device 1 can also be formed in such a simple form in which the mountain fold parts and the valley fold parts do not intersect.

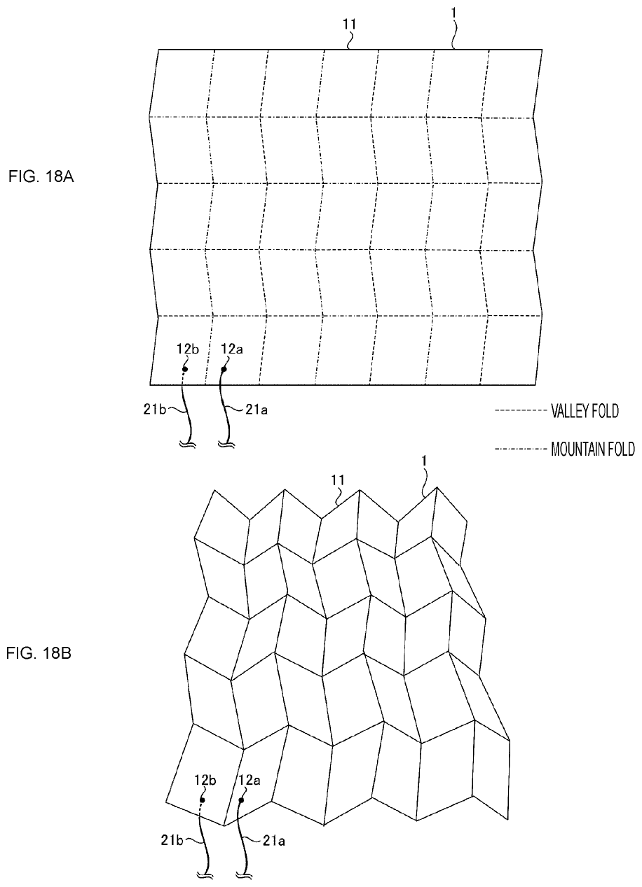

FIG. 18 is a diagram illustrating a configuration of the audio device 1 according to another modified example. FIG. 18(A) is a developed view of the audio device 1, and FIG. 18(B) is a perspective view of the audio device 1 bent to be formed into a three-dimensional shape. This method of bending has been used for, for example, folding a solar cell panel mounted on an artificial satellite, and is called miura-ori (registered trademark).

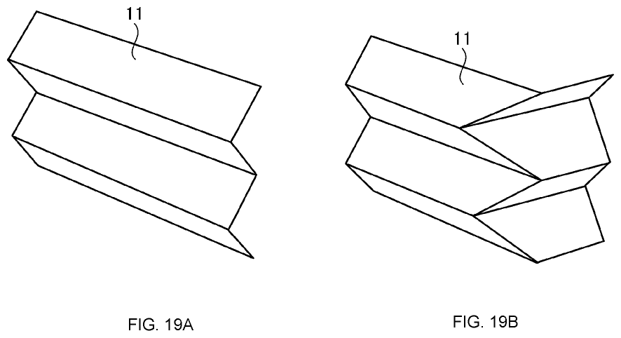

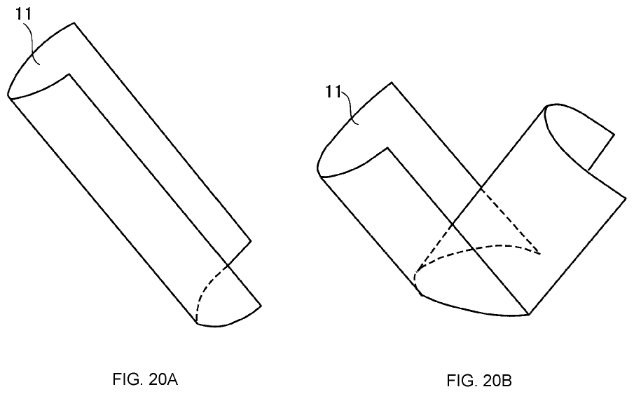

FIGS. 19 and 20 are diagrams explaining bending of the piezoelectric sheet 11 in other modified examples. Similarly to FIG. 17, FIG. 19(A) illustrates a state in which the piezoelectric sheet 11 is bent at mountain fold parts and valley fold parts that are alternately provided. The V-shaped groove shape formed by the mountain fold parts and the valley fold parts as described above can be bent as in FIG. 19(B) to form an appropriate form. Furthermore, such a method of bending can be applied not only to a V-shaped groove shape but also to a U-shaped groove shape.

FIG. 20(A) illustrates a state in which the piezoelectric sheet 11 is bent into a U shape. Note that not only in the piezoelectric sheet 11 that is bent but also in the piezoelectric sheet 11 that is only curved as described above, vibration parallel to the surface can be converted into vibration of air. FIG. 20(B) illustrates a state in which the U-shaped groove shape of FIG. 20(A) is bent. As the form in which the piezoelectric sheet 11 is bent as described above, various forms can be employed.

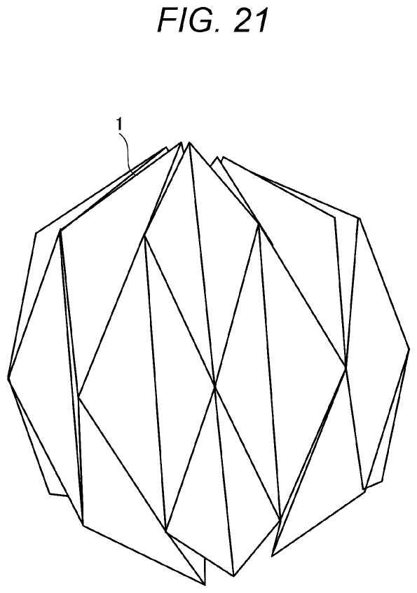

In the first and second embodiments, the audio device 1 is to be fixed to the fixing part 22. The audio device 1 not only can be fixed to the fixing part 22 but also can have a self-standing configuration. FIG. 21 is a diagram illustrating a configuration of the audio device 1. In the present embodiment, the piezoelectric sheet 11 is bent to form a substantially spherical three-dimensional shape. The audio device 1 bent to form a substantially spherical shape as described above can also stand on its own. In such a form, the audio reproducing apparatus 4 does not necessarily need to be fixed to the fixing part 22. Furthermore, the directivity of the sound can be such that sound is directed in all directions.

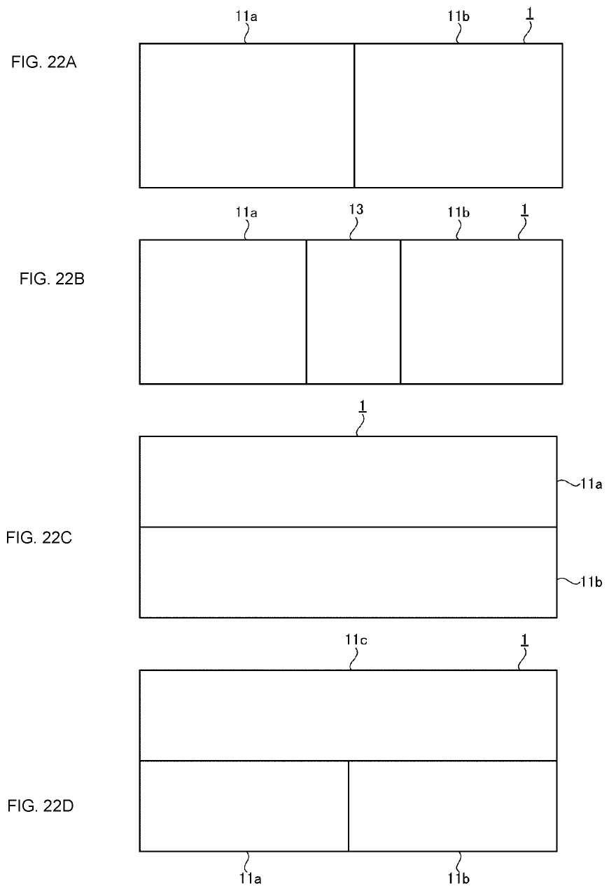

FIG. 22 shows diagrams illustrating various configurations of the audio device 1. In the first and second embodiments, the piezoelectric sheet 11 in which the drive region is not divided is to be used. Specifically, the piezoelectric sheet 11 includes one pair of electrode layers, and has one input signal channel. Instead of such a form, a form may be employed in which one audio device 1 is provided with different drive regions. FIGS. 22(A) to 22(D) each illustrate the audio device 1 before being bent. Note that these drawings omit fold parts, and the audio device 1 is to be configured by appropriate bending.

In FIG. 22(A), one audio device 1 is provided with two regions of piezoelectric sheets 11a and 11b, and the two regions are different drive regions. As a method of forming the two piezoelectric sheets 11a and 11b, various forms can be employed such as a form in which the electrode layer at the portion to be partition is removed in one piezoelectric sheet 11, and a form in which two piezoelectric sheets 11a and 11b are fixed to one reinforcing part. By forming the regions of the piezoelectric sheets 11a and 11b in one audio device 1 as described above, it is possible to input acoustic signals of different channels to the piezoelectric sheets 11a and 11b, respectively. Note that an electrode part for acoustic signal input is formed on each of the piezoelectric sheets 11a and 11b. According to such a form, different signals can be input to the left and the right in one audio device 1, respectively, and stereo reproduction or the like can be performed.

FIG. 22(B) illustrates a form in which a non-acoustic part is provided between the piezoelectric sheets 11a and 11b. For formation of the non-acoustic part, various forms can be employed such as a form in which the electrode layer is removed from the piezoelectric sheet, and a form in which two piezoelectric sheets 11a and 11b are fixed to a reinforcing part in a state in which an interval is provided between the piezoelectric sheets 11a and 11b. Also in this form, acoustic signals of different channels can be input to the piezoelectric sheets 11a and 11b, respectively, and thus stereo reproduction or the like can be realized. In particular, in the present embodiment, because the non-acoustic part 13 is provided, the sense of separation between the left and the right can be audibly improved in a case where stereo reproduction is performed.

FIG. 22(C) illustrates a form in which the direction of dividing into the piezoelectric sheets 11a and 11b is the longitudinal direction. As described above, in one audio device 1, an appropriate form can be employed for dividing into the piezoelectric sheets 11a and 11b, that is, for dividing of the drive region. FIG. 21(D) illustrates a three-divided form in which regions of piezoelectric sheets 11a, 11b, and 11c are included. According to such a form, the number of channels of the sound emitted from the audio device 1 is increased, and not only localization in the left-right direction but also localization in the upper and lower direction becomes possible, and further stereoscopic sound can be realized.

Note that in a case where a plurality of acoustic signals is input in FIGS. 22(A) to 22(D), a signal in which frequencies are partially cut off may be input to each of the piezoelectric sheets 11a to 11c. It is preferable to input a suitable frequency band in consideration of the position, the area, the shape, or the like of each of the piezoelectric sheets 11a to 11c. According to such a form, the piezoelectric sheets 11a to 11c can have different frequency characteristics, and suitable frequency characteristics can be also realized as a whole.

### 6. Fourth Embodiment

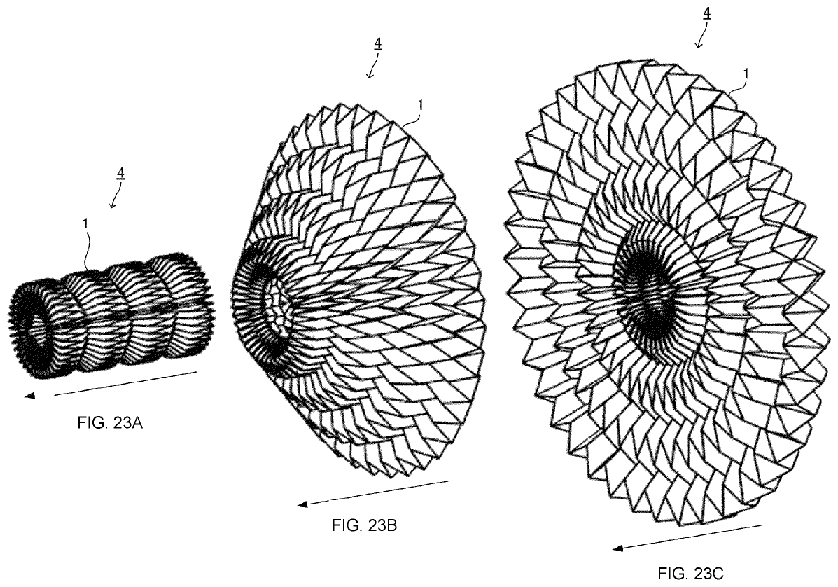

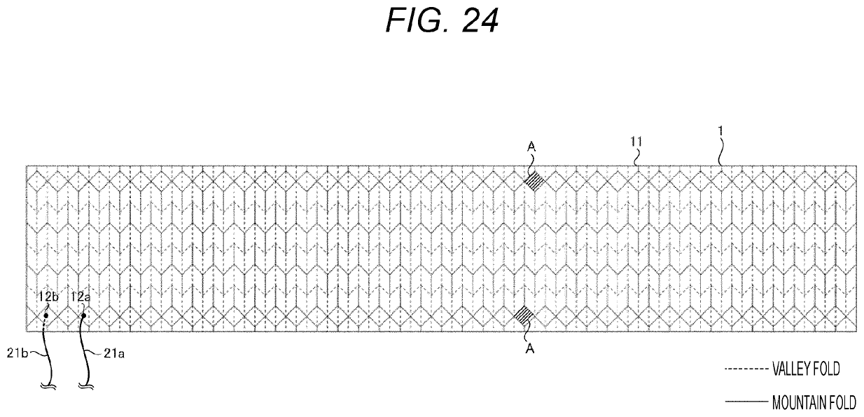

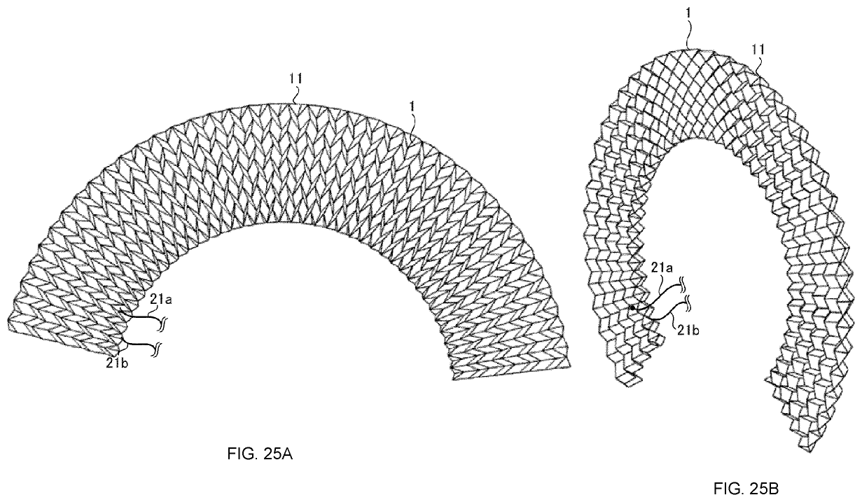

FIG. 23 is a diagram illustrating a configuration of the audio reproducing apparatus 4, FIG. 24 is a developed view of the audio device in FIG. 23, and FIG. 25 is a diagram illustrating a configuration of the audio device 1 in FIG. 23. As illustrated in FIG. 24 and illustrated in the developed view, the audio reproducing apparatus 4 illustrated in FIG. 23 includes the audio device 1 folded in mountain folds at solid line portions and folded in valley folds at broken line portions. Furthermore, an electrode part 12a to which a signal line 21a is connected is provided on one surface of the audio device 1, and an electrode part 12b to which a signal line 21b is connected is provided on the other surface.

In the developed view of FIG. 24, regions A having a substantially square rhombus shape by mountain fold are provided in the upper end and the lower end. An example of the region A at each of the upper end and the lower end of the audio device 1 is indicated by hatching. This is a region to reduce the radiation from the opposite surface in an acoustic device, and such a configuration in the end provides an opposite phase with respect to the surface of the acoustic device to cancel the sound, and thus prevents reduction in the sound pressure. In addition, showing of the back surface of the audio device 1 is suppressed, and the audio device 1 can be visually excellent.

FIG. 25 illustrates a state in which mountain folds and valley folds are formed in the audio device 1 in the developed diagram of FIG. 24. FIG. 25(A) is a front view of the audio device 1, and FIG. 25(B) is a perspective view of the audio device 1. Both the ends of the audio device illustrated in FIGS. 25(A) and 25(B) are fixed to each other by, for example, tying with a string-shaped fixing part, and thus the audio reproducing apparatus 4 in the form illustrated in FIG. 23 can be formed.

In a case where both the ends of the audio device 1 in FIG. 25 are fixed to each other, a disk shape as in FIG. 23(C) can be formed. The shape in FIG. 23(C) is changed to the cylindrical shape in FIG. 23(A) through the shape in FIG. 23(B) by applying a force in the direction of the arrow to the center part of the shape in FIG. 23(C). The reverse change is possible, so that the shape in FIG. 23(A) is changed to the shape in FIG. 23(B) and the shape in FIG. 23(C) by applying a force in the direction opposite to the arrow to the center part of the shape in FIG. 23(A). Furthermore, the shapes illustrated in FIGS. 23(A) to 23(C) can be each held at the position or the intermediate position in the shape change.

As described above, the audio reproducing apparatus 4 of the present embodiment can be used in the shapes illustrated in FIGS. 23(A) to 23(C) or the intermediate shapes thereof. Therefore, the shape can be changed according to the acoustic characteristic desired by a user or the use situation. In particular regarding to the acoustic characteristic, change to directivity desired by a user is possible. For example, in a case where unbiased directivity in which the sense of direction is lost is required for use, use in the form of FIG. 23(A) is possible, and in a case where narrow directivity in which the sense of direction is further imparted is required for use, change as in FIG. 23(C) is possible.

In the present embodiment, in the case of changing the form of the audio reproducing apparatus 4, the audio device 1 is to be directly touched to change the form of the audio reproducing apparatus 4. However, a jig or the like may be provided and operated so that the audio reproducing apparatus 4 can be changed from the contraction state as in FIG. 23(A) to the expansion state as in FIG. 23(C).

The audio reproducing apparatus 4 illustrated in FIGS. 23 to 25 is formed to have one channel input. The number of input channels to the audio reproducing apparatus 4 can be appropriately set by division into appropriate regions in the audio device 1. Hereinafter, a form including various input channels will be described.

### Fourth-1 Embodiment

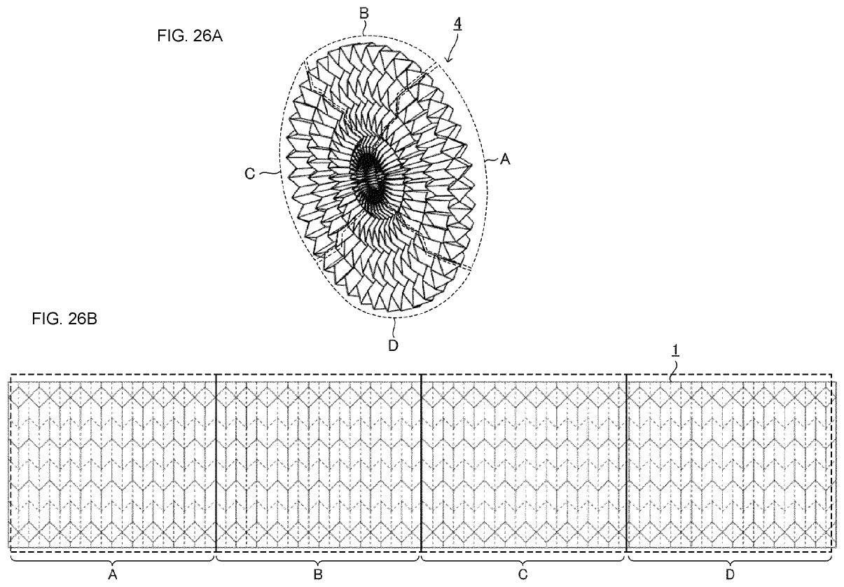

FIG. 26 is a diagram to explain a configuration of the audio reproducing apparatus 4, FIG. 26(A) is a perspective view of the audio reproducing apparatus 4, and FIG. 26(B) is a developed view of the audio device 1 in FIG. 26(A). In this embodiment, as illustrated in FIG. 26(B), the configuration is a four-divided configuration including regions A to D. The regions A to D are obtained by dividing the developed view of FIG. 26(B) in the vertical direction. In the case of such division, as illustrated in FIG. 26(A), the audio reproducing apparatus 4 includes the regions A to D formed by division into a pie chart shape. By providing the regions A to D with different channels (specifically, connecting a signal line to each of the regions A to D), a four-channel audio reproducing apparatus 4 speaker system can be configured.

Furthermore, in the audio reproducing apparatus 4 in FIG. 26(A), for example, two (for example, the regions A and B) of the four channels are allocated for left channels, and the remaining two (for example, the regions C and D) are allocated for right channels, and thus a two-channel audio reproducing apparatus 4 can be configured. Furthermore, by using one of the left channels and one of the right channels (for example, the region B from the left channels and the region C from the right channels) as a high frequency channel and using the other channels as a medium/low frequency channel, intended signal processing or the like can be performed at each channel, and a more suitable two-channel audio system can be configured.

### Fourth-2 Embodiment

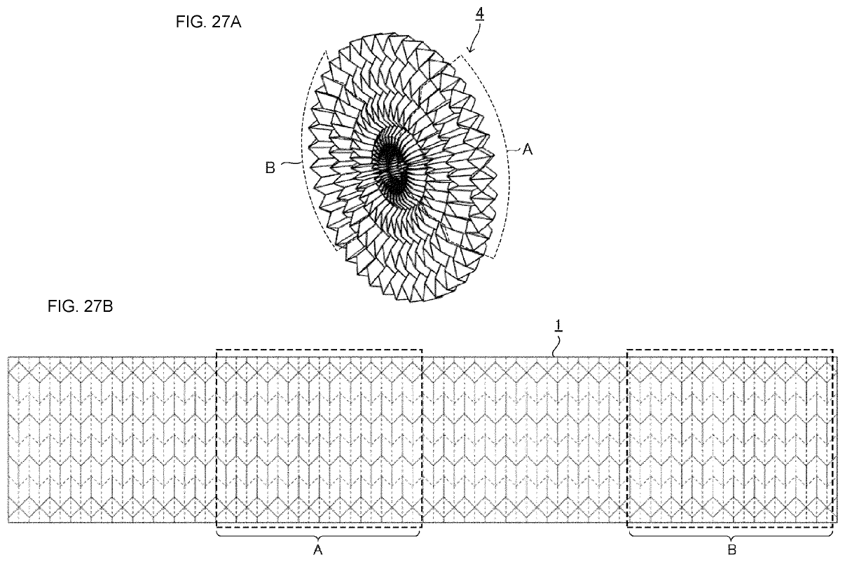

FIG. 27 is a diagram to explain a configuration of the audio reproducing apparatus 4, FIG. 27(A) is a perspective view of the audio reproducing apparatus 4, and FIG. 27(B) is a developed view of the audio device 1 in FIG. 27(A). In this embodiment, as illustrated in FIG. 27(B), regions A and B are included that are formed so as to have an interval therebetween. Note that in FIGS. 27(A) and 27(B), portions other than the regions A and B may be a sheet having no electrode layer. Alternatively, in <Fourth-1 Embodiment> explained with reference to FIG. 26, two (for example, the regions A and C) of the four channels may be allocated for a left channel and a right channel, respectively, and the regions B and D may be set to no signal (silence).

### Fourth-3 Embodiment

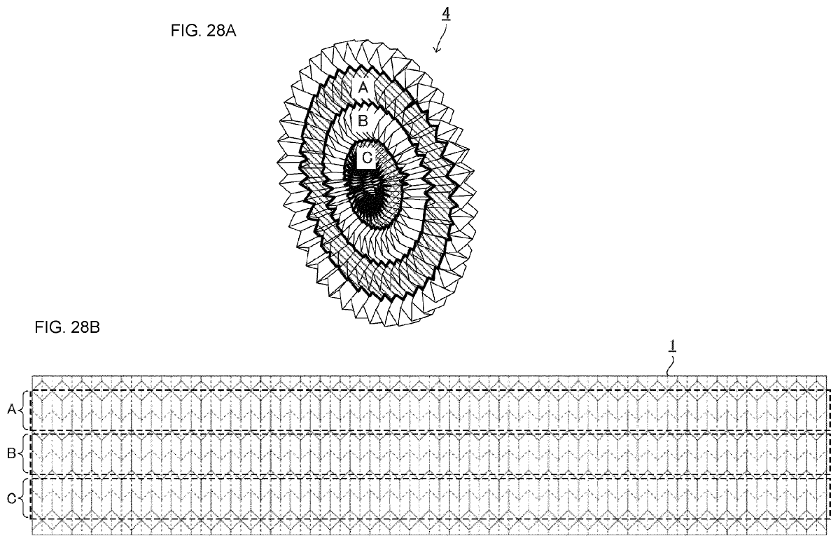

FIG. 28 is a diagram to explain a configuration of the audio reproducing apparatus 4, FIG. 28(A) is a perspective view of the audio reproducing apparatus 4, and FIG. 28(B) is a developed view of the audio device 1 in FIG. 28(A). In this embodiment, as illustrated in FIG. 28(B), the configuration is a three-divided configuration including regions A to C. The regions A to C are obtained by dividing the developed view of FIG. 28(B) in the lateral direction. In the case of such division, as illustrated in FIG. 28(A), the audio reproducing apparatus 4 includes the regions A to C formed by division into a concentric shape. In such an embodiment, a more suitable audio system can be configured by, for example, giving signals subjected to signal processing suitable for high frequency, middle frequency, and low frequency to the regions A to C, respectively.

Furthermore, division into total 12 regions is given by adding division into the 4 regions in FIG. 27 to the division into the 3 regions in FIG. 28, and thus the fourth-2 embodiment and the fourth-3 embodiment can be switched. As a result, a more versatile and suitable audio system can be configured.

### Fourth-4 Embodiment

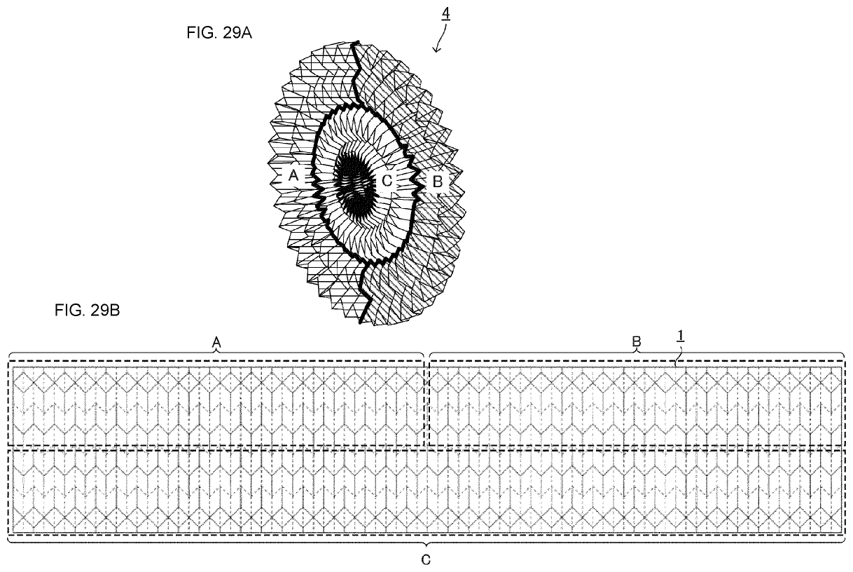

FIG. 29 is a diagram to explain a configuration of the audio reproducing apparatus 4, FIG. 29(A) is a perspective view of the audio reproducing apparatus 4, and FIG. 29(B) is a developed view of the audio device 1 in FIG. 29(A). In this embodiment, as illustrated in FIG. 29(B), regions are obtained by division into upper and lower regions, and only one of the regions (in this case, the upper region) is vertically divided. In such a division form, as illustrated in FIG. 29(A), a region C can be formed in the center of a concentric circle, and regions A and B can be formed in the left and the right of the outer side of the concentric circle, respectively. In such an embodiment, for example, the region C in the center of the concentric circle is allocated for a center channel, and the regions A and B in the outer side of the concentric circle are allocated for a left channel and a right channel, respectively, and thus an audio reproducing apparatus 4 excellent in sound image localization can be realized.

Furthermore, such a channel allocation form can take advantage of the characteristic that an expanded form as in FIG. 23(C) has straightness to realize directivity in which further separation is provided. Meanwhile, in a closed form as in FIG. 23 (A), the sense of direction can be eliminated, and therefore sound reproduction in which three channels are mixed can be performed without processing such as mixing among the three channels in advance.

### Fourth-5 Embodiment

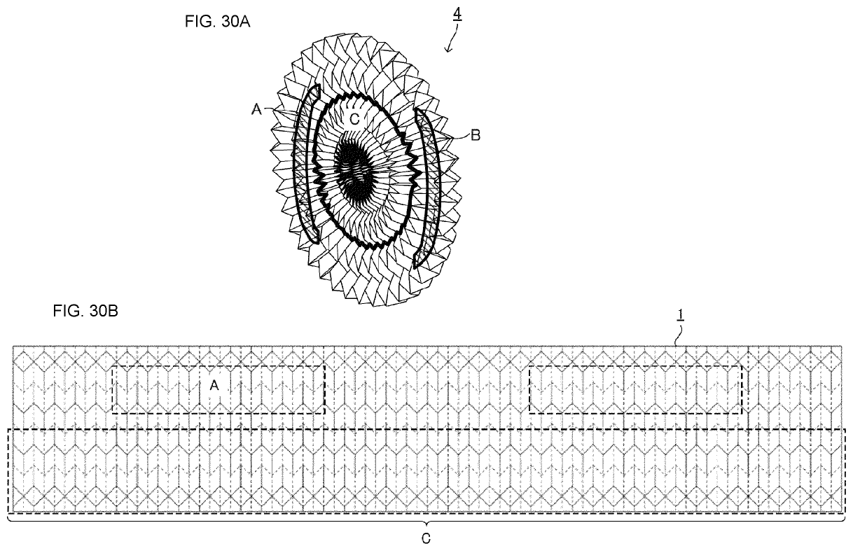

FIG. 30 is a diagram to explain a configuration of the audio reproducing apparatus 4, FIG. 30(A) is a perspective view of the audio reproducing apparatus 4, and FIG. 30(B) is a developed view of the audio device 1 in FIG. 30(A). In this embodiment, as illustrated in FIG. 30(B), the form is such that regions are obtained by division into upper and lower regions, the lower region is set as a region C, a part of the upper region is set as a region A, and the other part of the upper region is set as a region B. By providing the regions A to C as described above, as illustrated in FIG. 30(A), the region C can be formed in the center of a concentric circle, and the regions A and B can be formed in a part of the left region and a part of the right region in the outer side of the concentric circle, respectively.

In such an embodiment, for example, it is conceivable that the region C in the center of the concentric circle is allocated for a center channel, and the regions A and B provided in the outer side of the concentric circle are allocated for a left channel and a right channel, respectively. In such an example, in particular, the separation between the channels can be suitably improved because the left and the right channels are separated. Furthermore, interference between the channels also can be suppressed.

Although fourth-1 to fourth-5 embodiments are taken as an example to explain a form having various input channels, setting of a region in the audio device 1 is freely performed within a range in which an electrical defect such as a short circuit in an electrode layer provided in each region is not caused at the time of preparing the region.

Furthermore, in the case of providing no gap between the regions in FIGS. 26 to 30, a purpose of reinforcement or sound quality adjustment may be achieved by bonding a plurality of audio devices 1 without a gap to a sheet other than the audio devices 1. Alternatively, the purpose can be achieved by connecting a plurality of audio devices 1 to each other. Furthermore, in the case of arranging a gap between the regions as in FIG. 30 and the like, the purpose can be also achieved by bonding an audio device 1 to a predetermined position of another sheet. Furthermore, audio devices 1 may overlap with each other when bonded to another sheet.

### 7. Fifth Embodiment

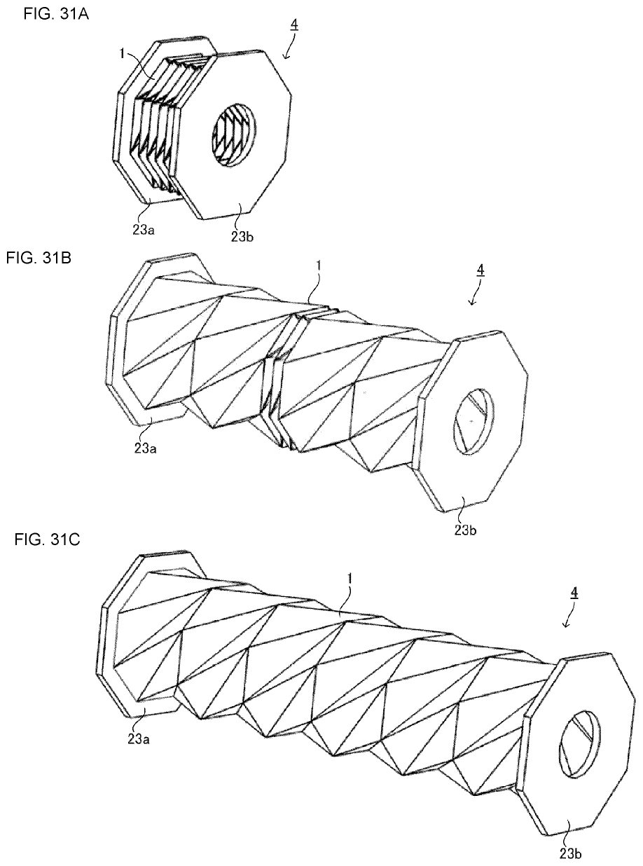

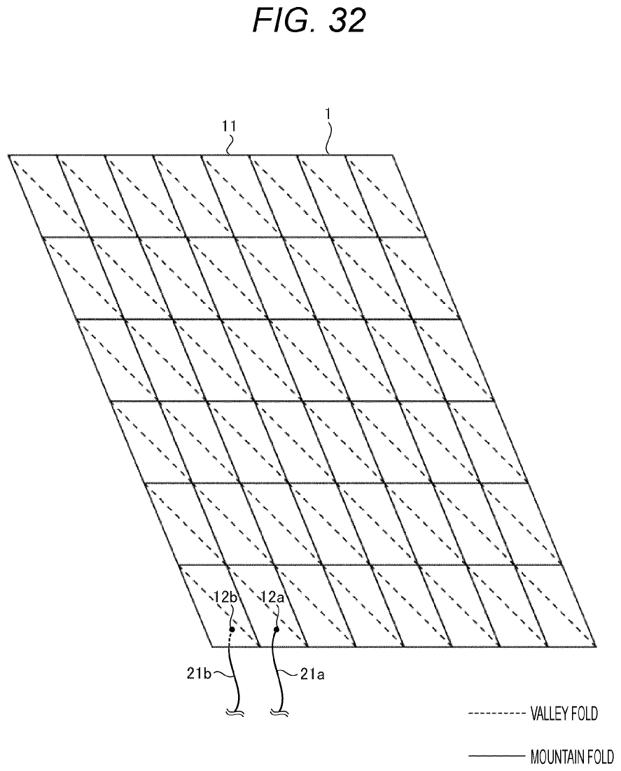

FIG. 31 is a diagram illustrating a configuration of the audio reproducing apparatus 4, and FIG. 32 is a developed view of the audio device 1 in FIG. 31. As illustrated in FIG. 32, the audio device 1 used in the present embodiment has a parallelogram shape as a whole. Furthermore, the audio device 1 is folded in mountain folds at positions of solid lines with which parallelogram shapes are sectioned off, and then folded in valley folds at positions of broken lines that are one diagonal line of the parallelograms. Furthermore, an electrode part 12a to which a signal line 21a is connected is provided on one surface of the audio device 1, and an electrode part 12b to which a signal line 21b is connected is provided on the other surface.

In the audio reproducing apparatus 4 of the present embodiment, the audio device 1 is folded, and a first base part 23a and a second base part 23b including a hard material are provided on both the ends. The first base part 23a and the second base part 23b are provided with a hole in the center. Through this hole, the internal pressure generated by driving the audio device 1 is released to the outside to generate a bass reflex effect for enhancement of bass.

The audio reproducing apparatus 4 can be changed from a state in which the audio device 1 is folded (contraction state) as illustrated in FIG. 31(A) to a state in which the audio device 1 is expanded (expansion state) as in FIGS. 31(B) and 31(C). As described above, the shape of the audio reproducing apparatus 4 of the present embodiment can be changed by using the audio device 1 having a cylindrical shape capable of expanding and contracting. Furthermore, the audio device 1 can hold the shape at a plurality of positions before and after the shape change and in the middle of the shape change.

Specifically, from the state of FIG. 31(A), the audio device 1 is pulled at a first base part 23a and a second base part 23b provided at both the ends in the direction of widening the interval therebetween. At this time, one of the first base part 23a and the second base part 23b is rotated so that the audio device 1 is expanded. Then, stages (in the present embodiment, six stages) provided for the audio device 1 are each opened one by one. The state of FIG. 31(B) is a state in which among the six stages, the left two and the right two stages are each opened, and the middle two stages are closed. The state of FIG. 31(C) is a state in which among the six stages, all the stages are opened. As described above, the sound reproducing apparatus 4 of the present embodiment can hold the shape at a plurality of expanded and contracted positions by using the fold parts that make expansion and contraction possible.

In the configuration in FIGS. 31(A) to 31(C), the audio device 1 has a cross section having an octagonal tubular shape. In such a configuration, the eight vertexes move to the adjacent vertex position in the clockwise direction to obtain the rotation amount, and thus one of the six folding stages is in a stably expanded state. Each state can be stably maintained, and therefore, in addition to a laterally expanded configuration as in FIGS. 31(A) to 31(C), use in a standing state is also possible in which one of the first base part 23a and the second base part 23b is set as a bottom surface.

As described above, the audio reproducing apparatus 4 of the present embodiment can stably maintain the shapes in FIGS. 31(A) to 31(C) or the intermediate shapes thereof on the same principle as origami. Furthermore, the amount of sound pressure can be changed by changing the shape of the audio reproducing apparatus 4. Specifically, while the sound pressure is small in the state of FIG. 31(A), the sound pressure can be increased in the state of FIG. 31(C).

### 8. Sixth Embodiment

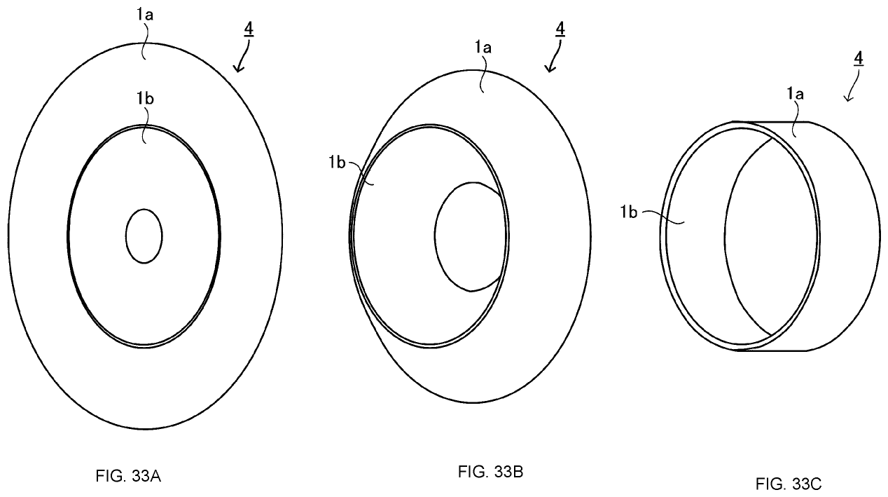

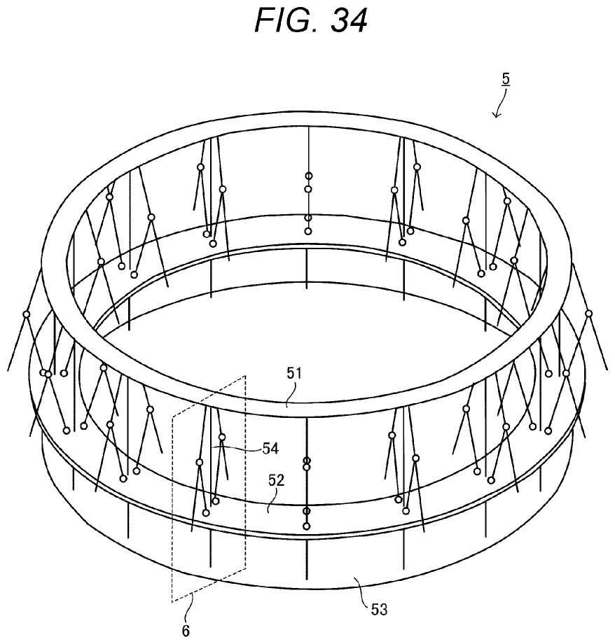

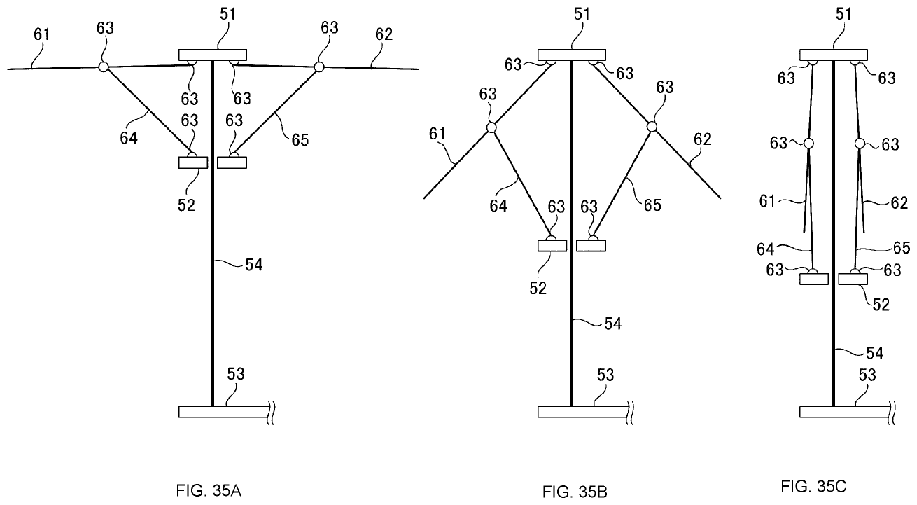

FIG. 33 is a diagram illustrating a configuration of the audio reproducing apparatus 4, FIG. 34 is a diagram illustrating an operation part 5 of the audio reproducing apparatus 4, and FIG. 35 is a diagram to explain the operation of an opening/closing part 6. As illustrated in FIGS. 33(A) to 33(C), the audio reproducing apparatus 4 of the present embodiment includes two audio devices 1a and 1b. The audio devices 1a and 1b in FIGS. 33(A) to 33(C) are schematically illustrated, and actually have a plurality of mountain folds and valley folds and are configured to expand and contract as explained with reference to FIG. 23. For example, audio devices 1a and 1b having a plurality of mountain folds and valley folds are fixed using a first fixing part 61 and a second fixing part 62 in FIG. 35(A), 35(B), or 35(C) described later as a frame. Both the first audio device 1a and the second audio device 1b have an annular shape, and the first audio device 1a is arranged so as to surround the second audio device 1b. Furthermore, the second audio device 1b is provided with a hole in the center.

The audio reproducing apparatus 4 of the present embodiment can be in at least two held states by applying a force in a direction different from the direction in which a force is applied for folding. In a state in which both the audio devices 1a and 1b are expanded, a disk-shaped sound reproduction portion is formed as in FIG. 33(A). Furthermore, in a state in which both the audio devices 1a and 1b are folded, a tubular state is observed in the case of observation from the front as in FIG. 33(C). Furthermore, at an intermediate position in FIG. 33(B) between the positions in FIGS. 33(A) and 33(C), an annular shape is formed that has a ridge at the boundary between the two audio devices 1a and 1b.

Such shape change in the audio devices 1a and 1b can be realized with, for example, the operation part 5 illustrated in FIG. 34. The operation part 5 includes a base 53, a ring part 51, a plurality of fixing rods 54 connecting the base 53 with the ring part 51, a movable ring part 52 through which the fixing rods 54 are provided, and opening/closing parts 6 provided for the fixing rods 54, respectively. The opening/closing parts 6 can operate by moving the movable ring part 52 up and down to realize the movement of the audio devices 1a and 1b explained with reference to FIG. 33.

FIG. 35 is a diagram to explain an operation of the opening/closing part 6. The opening/closing part 6 includes a first fixing part 61 and a second fixing part 62 that are connected to the ring part 51 with hinge parts 63, a first support part 64 connected to the first fixing part 61 and the movable ring part 52 with hinge parts 63, and a second support part 65 connected to the second fixing part 62 and the movable ring part 52 with hinge parts 63. By fixing the first audio device 1a to the first fixing part 61 and fixing the second audio device 1b to the second fixing part 42, the movement in FIGS. 33(A) to 33(C) can be realized.

FIG. 35(A) illustrates a state in which the movable ring part 52 is positioned upward, and at this time, the first fixing part 61 and the second fixing part 62 are opened. Therefore, the audio devices 1a and 1b are in the state of FIG. 33(A). FIG. 35(B) illustrates a state in which the movable ring part 52 is lowered from the state of FIG. 35(A). At this time, the first fixing part 61 and the second fixing part 62 are slightly closed. Therefore, the audio devices 1a and 1b are in the state of FIG. 33(B). FIG. 35(C) illustrates a state in which the movable ring part 52 is further lowered from the state of FIG. 35(B). At this time, the first fixing part 61 and the second fixing part 62 are closed. Therefore, the audio devices 1a and 1b are in the state of FIG. 33(C).

According to the present embodiment, the directivity of the audio reproducing apparatus 4 can be changed by providing the two audio devices 1a and 1b configured to open and close. Specifically, in the state of FIG. 33(A), the sense of direction can be imparted, and the sound can be heard far in the front direction. Meanwhile, by changing the state to the state of FIG. 33(B) and the state of FIG. 33(C), the sense of direction can be eliminated, and the sound can be heard without a sense of direction and without bias.

As described above, in the present embodiment, an acoustic characteristic desired by a user can be realized by combining the plurality of audio devices 1a and 1b and making each of the audio devices 1a and 1b capable of expanding and contracting.

### 9. Seventh Embodiment

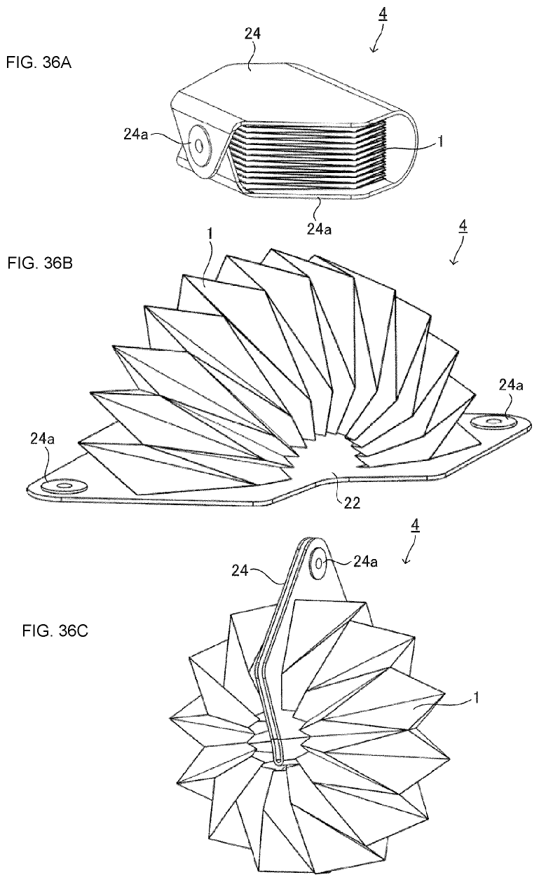

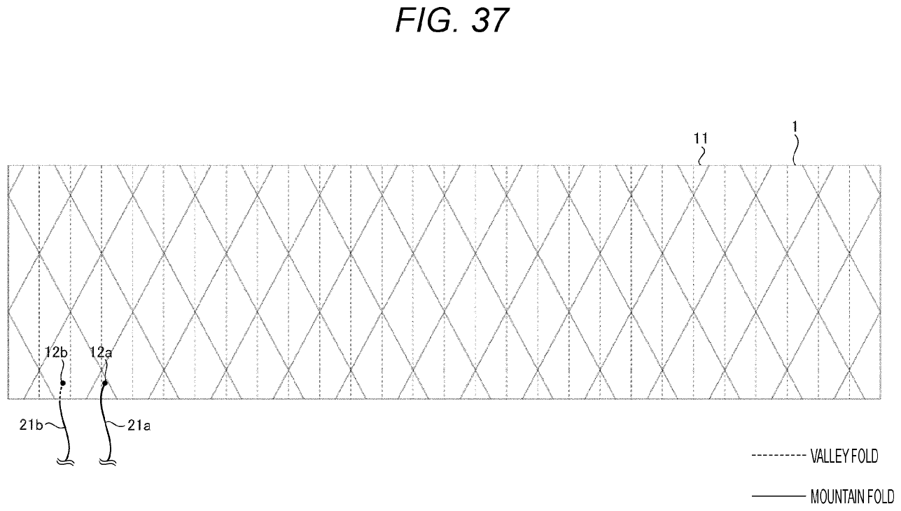

FIG. 36 is a diagram illustrating a configuration of the audio reproducing apparatus 4, and FIG. 37 is a developed view of the audio device 1 in FIG. 36. With reference to FIGS. 12 to 16 (third embodiment), the audio reproducing apparatus 4 is explained that includes the audio device 1 accommodated in the fixing part 22. The audio reproducing apparatus 4 illustrated in FIG. 36 is the same as that in the third embodiment in that a fixing part 24 is similarly used.

As illustrated in FIG. 37, the audio device 1 used in the present embodiment has a laterally long rectangular shape, and is formed by folding in mountain folds at solid lines and folding in valley folds at broken lines. Furthermore, an electrode part 12a to which a signal line 21a is connected is provided on one surface of the audio device 1, and an electrode part 12b to which a signal line 21b is connected is provided on the other surface.

Such an audio device 1 is accommodated in the fixing part 24 in a folded state as illustrated in FIG. 36(A). Both the ends of the audio device 1 are each fixed to the fixing part 24. Furthermore, two fasteners 24a are provided in both the ends of the fixing part 24, and the fasteners 24a prevent, by fixing to each other, the fixing part 24 from opening inadvertently. As the fastener 24a, a snap fastener, and in addition, a magnet fastener can be used.

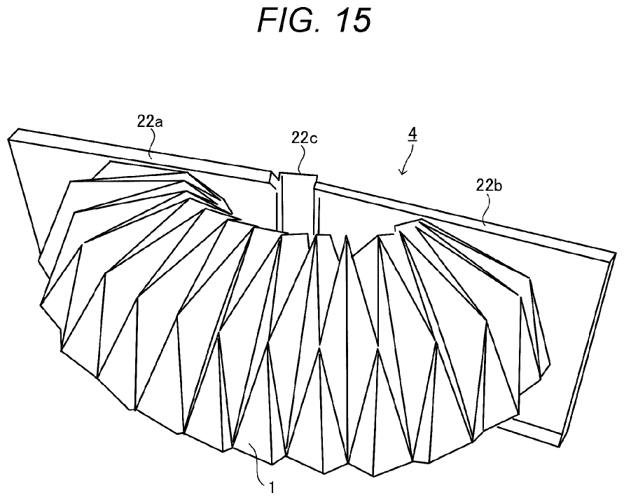

FIG. 36(B) illustrates a state in which the fasteners 24a are released and the audio device 1 is developed. In such a state, the audio reproducing apparatus 4 having wide directivity similarly to that in FIG. 15 can be realized. The state of FIG. 36(C) can be obtained by further opening the fixing part 24 from the state of FIG. 36(B), specifically, by opening the fixing part 24 until the fixing part 24 is bent over on itself. In the state of FIG. 36(C), the audio device 1 is expanded over the entire circumference, and directivity wider than that in FIG. 36(B) can be realized. Furthermore, the open state can be maintained by coupling the two fasteners 24a to each other.

The fastener 24a may be provided with a hole in the center. In the state of FIG. 36(C), a strap or the like can be passed through the hole provided for the fastener 24a to facilitate carrying in the developed state.

The present disclosure can also be realized by an apparatus, a method, a system, or the like. Furthermore, the matters described in embodiments and modified examples can be appropriately combined.

Note that an effect described in the present description is not necessarily limited, and may be any effect described in the present disclosure. Furthermore, contents of the present disclosure are not to be construed as being limited by an exemplified effect.

The present disclosure can also adopt the following configurations.

(1)

An audio reproducing apparatus including

an audio device including a thin film material including a first electrode layer, a second electrode layer, and a capacitive layer sandwiched between the first electrode layer and the second electrode layer, the audio device having a three-dimensional shape formed by providing the thin film material with a plurality of fold parts.

(2)

The audio reproducing apparatus according to the item (1), in which

the plurality of fold parts includes a plurality of mountain fold parts and a plurality of valley fold parts.

(3)

The audio reproducing apparatus according to the item (2), in which

the plurality of fold parts includes points at which the plurality of mountain fold parts and the plurality of valley fold parts intersect, respectively.

(4)

The audio reproducing apparatus according to the item (2) or (3), in which the plurality of fold parts includes

the plurality of valley fold parts arranged to be parallel to each other and

the plurality of mountain fold parts arranged to be parallel to each other but not parallel to the plurality of valley fold parts.

(5)

The audio reproducing apparatus according to any one of the items (2) to (4), in which the plurality of fold parts includes

the plurality of valley fold parts that has a zigzag shape and is arranged to be parallel to each other,

the plurality of mountain fold parts that is parallel to the plurality of valley fold parts and arranged alternately with the plurality of valley fold parts, and

connecting parts that are arranged to connect vertexes of the plurality of mountain fold parts with adjacent vertexes of the plurality of valley fold parts, the connecting parts at which fold is different from fold at adjacent connecting parts.

(6)

The audio reproducing apparatus according to any one of the items (2) to (5), in which

at least one of section regions sectioned off with the plurality of mountain fold parts and the plurality of valley fold parts is different in area from other section regions.

(7)

The audio reproducing apparatus according to the item (1), in which

the audio device is capable of expanding and contracting with the plurality of fold parts.

(8)

The audio reproducing apparatus according to the item (7), in which

the audio device is fixed to a fixing part that is capable of opening and closing, and

the audio device is configured to expand and contract by opening and closing of the fixing part.

(9)

The audio reproducing apparatus according to any one of the items (1) to (8), in which

the audio device has a plurality of drive regions.

(10)

The audio reproducing apparatus according to the item (9), in which

the plurality of drive regions is provided so as to have an interval between the plurality of drive regions.

(11)

The audio reproducing apparatus according to any one of the items (1) to (10), in which

the audio device further includes a reinforcing part bonded to the thin film material.

(12)

The audio reproducing apparatus according to any one of the items (1) to (11), in which

the audio device is capable of expanding and contracting with the plurality of fold parts, and

the audio device is capable of holding a shape at a plurality of positions to which the audio device expands and contracts.

(13)

The audio reproducing apparatus according to the items (1) to (12), in which

the audio device is capable of expanding and contracting with the plurality of fold parts, and

the audio device has a shape changeable to a plurality of shapes.

(14)

The audio reproducing apparatus according to the item (13), in which

the audio device has a shape changeable from a cylindrical shape to a disk shape.

(15)

The audio reproducing apparatus according to the item (13), in which

the audio device has a cylindrical shape capable of expanding and contracting.

(16)

The audio reproducing apparatus according to the item (13), further including

an operation part configured to change a shape of the audio device.

(17)

The audio reproducing apparatus according to the item (13), further including

a plurality of audio devices having a shape changeable to a plurality of shapes.

(18)

The audio reproducing apparatus according to claim 17, in which

the plurality of audio devices is configured to change in shape in combination with each other.

(19)

An audio device including

a thin film material including a first electrode layer, a second electrode layer, and a capacitive layer sandwiched between the first electrode layer and the second electrode layer, the audio device having a three-dimensional shape formed by providing the thin film material with a plurality of fold parts.

### REFERENCE SIGNS LIST

(1a, 1b) Audio device
4 Audio reproducing apparatus
11 (11a to 11c) Piezoelectric sheet
12a Electrode part
12b Electrode part
13 Non-acoustic part
21a, 21b Signal line
22 Fixing part
22a First base part
22b Second base part
22c Hinge part
22d Left fixing part
22e Right fixing part
24 Fixing part
24a Fastener
5 Operation part
51 Ring part
52 Movable ring part
53 Base
54 Fixing rod
6 Opening/closing part
61 First fixing part
62 Second fixing part
63 Hinge part
64 First support part
65 Second support part

1. An audio reproducing apparatus comprising
an audio device including a thin film material including a first electrode layer, a second electrode layer, and a capacitive layer sandwiched between the first electrode layer and the second electrode layer, the audio device having a three-dimensional shape formed by providing the thin film material with a plurality of fold parts.

2. The audio reproducing apparatus according to claim 1, wherein
the plurality of fold parts includes a plurality of mountain fold parts and a plurality of valley fold parts.

3. The audio reproducing apparatus according to claim 2, wherein
the plurality of fold parts includes points at which the plurality of mountain fold parts and the plurality of valley fold parts intersect, respectively.

4. The audio reproducing apparatus according to claim 2, wherein the plurality of fold parts includes
the plurality of valley fold parts arranged to be parallel to each other and
the plurality of mountain fold parts arranged to be parallel to each other but not parallel to the plurality of valley fold parts.

5. The audio reproducing apparatus according to claim 2, wherein the plurality of fold parts includes
the plurality of valley fold parts that has a zigzag shape and is arranged to be parallel to each other,
the plurality of mountain fold parts that is parallel to the plurality of valley fold parts and arranged alternately with the plurality of valley fold parts, and
connecting parts that are arranged to connect vertexes of the plurality of mountain fold parts with adjacent vertexes of the plurality of valley fold parts, the connecting parts at which fold is different from fold at adjacent connecting parts.

6. The audio reproducing apparatus according to claim 2, wherein
at least one of section regions sectioned off with the plurality of mountain fold parts and the plurality of valley fold parts is different in area from other section regions.

7. The audio reproducing apparatus according to claim 1, wherein
the audio device is capable of expanding and contracting with the plurality of fold parts.

8. The audio reproducing apparatus according to claim 7, wherein
the audio device is fixed to a fixing part that is capable of opening and closing, and
the audio device is configured to expand and contract by opening and closing of the fixing part.

9. The audio reproducing apparatus according to claim 1, wherein
the audio device has a plurality of drive regions.

10. The audio reproducing apparatus according to claim 9, wherein
the plurality of drive regions is provided so as to have an interval between the plurality of drive regions.

11. The audio reproducing apparatus according to claim 1, wherein
the audio device further includes a reinforcing part bonded to the thin film material.

12. The audio reproducing apparatus according to claim 1, wherein
the audio device is capable of expanding and contracting with the plurality of fold parts, and
the audio device is capable of holding a shape at a plurality of positions to which the audio device expands and contracts.

13. The audio reproducing apparatus according to claim 1, wherein
the audio device is capable of expanding and contracting with the plurality of fold parts, and
the audio device has a shape changeable to a plurality of shapes.

14. The audio reproducing apparatus according to claim 13, wherein
the audio device has a shape changeable from a cylindrical shape to a disk shape.

15. The audio reproducing apparatus according to claim 13, wherein
the audio device has a cylindrical shape capable of expanding and contracting.

16. The audio reproducing apparatus according to claim 13, further comprising
an operation part configured to change a shape of the audio device.

17. The audio reproducing apparatus according to claim 13, further comprising
a plurality of audio devices having a shape changeable to a plurality of shapes.

18. The audio reproducing apparatus according to claim 17, wherein
the plurality of audio devices is configured to change in shape in combination with each other.

19. An audio device comprising
a thin film material including a first electrode layer, a second electrode layer, and a capacitive layer sandwiched between the first electrode layer and the second electrode layer, the audio device having a three-dimensional shape formed by providing the thin film material with a plurality of fold parts.
